(19) United States
(12) Patent Application Publication
(10) Pub. No.: US 2025/0294620 A1
(43) Pub. Date: Sep. 18, 2025

(54) METHOD AND APPARATUS FOR PROVIDING INFORMATION OF AMBIENT IOT DEVICE IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW); Yu-Hsuan Guo, Taipei City (TW); Ming-Che Li, Taipei City (TW); Wei-Han Lai, Taipei City (TW)

(21) Appl. No.: 19/077,724

(22) Filed: Mar. 12, 2025

Related U.S. Application Data
(60) Provisional application No. 63/565,231, filed on Mar. 14, 2024.

(51) Int. Cl. H04W 74/0833; H04W 52/02; H04W 52/36

(52) U.S. Cl. CPC H04W 74/0833; H04W 52/0261; H04W 52/365

(57) ABSTRACT

Methods, systems, and apparatuses are provided for providing information of Ambient Internet of Things (IoT) devices in a wireless communication system, wherein a method of a User Equipment (UE) comprises receiving a first signaling of triggering a random access procedure, triggering the random access procedure in response to receiving the first signaling, performing a first transmission during the random access procedure, and providing, in the first transmission, an energy information indicating at least one of: whether remaining energy of the UE is sufficient or not for one or more following transmissions or receptions after the first transmission, the remaining energy of the UE is insufficient for the one or more following transmissions or receptions after the first transmission, whether the remaining energy of the UE is sufficient or not to complete the random access procedure, and/or the remaining energy of the UE is insufficient to complete the random access procedure.

### CROSS-REFERENCE TO RELATED APPLICATIONS

The present Application claims priority to and the benefit of U.S. Provisional Patent Application Ser. No. 63/565,231, filed Mar. 14, 2024, which is fully incorporated herein by reference.

### FIELD

This disclosure generally relates to wireless communication networks and, more particularly, to a method and apparatus for providing information of Ambient Internet of Things (A-IoT) devices in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for providing information of ambient Internet of Things (IoT) devices in a wireless communication system. An ambient IoT User Equipment (UE)/device could perform and/or complete transmissions with limited power. The present invention allows an ambient IoT UE/device to indicate to the network whether it is able to perform or complete a procedure (e.g., a random access procedure) based on its remaining energy, assisting the network in scheduling multiple procedures for a large number of ambient IoT devices (e.g., triggering by one service).

In various embodiments, a method of a UE comprises receiving a first signaling of triggering a random access procedure, triggering the random access procedure in response to receiving the first signaling, performing a first transmission during the random access procedure, and providing, in the first transmission, an energy information indicating at least one of: whether remaining energy of the UE is sufficient or not for one or more following transmissions or receptions after the first transmission, the remaining energy of the UE is insufficient for the one or more following transmissions or receptions after the first transmission, whether the remaining energy of the UE is sufficient or not to complete the random access procedure, and/or the remaining energy of the UE is insufficient to complete the random access procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.1.1-1: Topology 1, from 3GPP TR 38.848 V18.0.0.

FIG. 6 is a reproduction of FIG. 4.2.1.2-1: Topology 2, from 3GPP TR 38.848 V18.0.0.

FIG. 7A is a reproduction of FIG. 9.2.6-1: Random Access Procedures-(a) CBRA with 4-step RA type, from 3GPP TS 38.300 V17.6.0.

FIG. 7B is a reproduction of FIG. 9.2.6-1: Random Access Procedures-(b) CBRA with 2-step RA type, from 3GPP TS 38.300 V17.6.0.

FIG. 7C is a reproduction of FIG. 9.2.6-1: Random Access Procedures-(c) CFRA with 4-step RA type, from 3GPP TS 38.300 V17.6.0.

FIG. 7D is a reproduction of FIG. 9.2.6-1: Random Access Procedures-(d) CFRA with 2-step RA type, from 3GPP TS 38.300 V17.6.0.

FIG. 8 is a reproduction of FIG. 5.7.4.1-1: UE Assistance Information, from [5] 3GPP TS 38.331 V18.0.0.

FIG. 9 is an example diagram showing that a network would trigger an ambient IoT device to perform a first procedure, and in response to receiving a first signaling from the network, the ambient IoT device would perform one or more D2R transmission(s) and/or R2D reception(s) during the first procedure, in accordance with embodiments of the present invention.

FIG. 10 is an example diagram showing that a network would trigger an ambient IoT device to perform a first procedure, and in response to receiving a first signaling from the network, the ambient IoT device would perform one or more D2R transmission(s) and/or R2D reception(s) during the first procedure, in accordance with embodiments of the present invention.

FIG. 11 is a flow diagram of a method of a UE comprises receiving a first signaling from a network, initiating a first procedure in response to receiving the first signaling, transmitting a first transmission to the network, receiving, from the network, a response corresponding to the first transmission, determining, based on at least a condition, to generate and/or transmit a first information, and transmitting a second transmission, to the network, comprising the first information, in accordance with embodiments of the present invention.

FIG. 12 is a flow diagram of a method of a UE in a wireless communication system comprising receiving a first signaling of triggering a random access procedure, triggering the random access procedure in response to receiving the first signaling, performing a first transmission during the random access procedure, and providing, in the first transmission, an energy information indicating at least one of: whether remaining energy of the UE is sufficient or not for one or more following transmissions or receptions after the first transmission, the remaining energy of the UE is insufficient for the one or more following transmissions or receptions after the first transmission, whether the remaining energy of the UE is sufficient or not to complete the random access procedure, and/or the remaining energy of the UE is insufficient to complete the random access procedure, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234058, “Study on solutions for Ambient IoT (Internet of Things) in NR.”; [2] 3GPP TR 38.848 V18.0.0 (2023-09) 3GPP; TSG RAN; Study on Ambient IoT (Internet of Things) in RAN (Release 18); [3] 3GPP TS 38.300 V18.0.0 (2023-12) 3GPP; TSG RAN; NR; NR and NG-RAN Overall Description (Release 18); [4] 3GPP TS 38.321 V18.0.0 (2023-12) 3GPP; TSG RAN; NR; MAC protocol specification (Release 18); [5] 3GPP TS 38.331 V18.0.0 (2023-12) 3GPP; TSG RAN; NR; RRC protocol specification (Release 18); [6] 3GPP TS 38.213 V18.1.0 (2023-12) 3GPP; TSG RAN; NR; Physical layer procedures for control (Release 18). The standards and documents listed above are hereby expressly and fully incorporated herein by reference in their entirety.

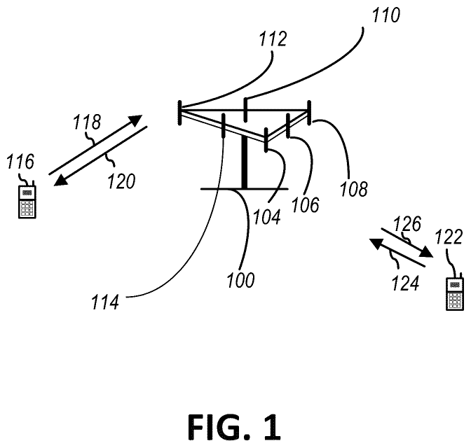

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

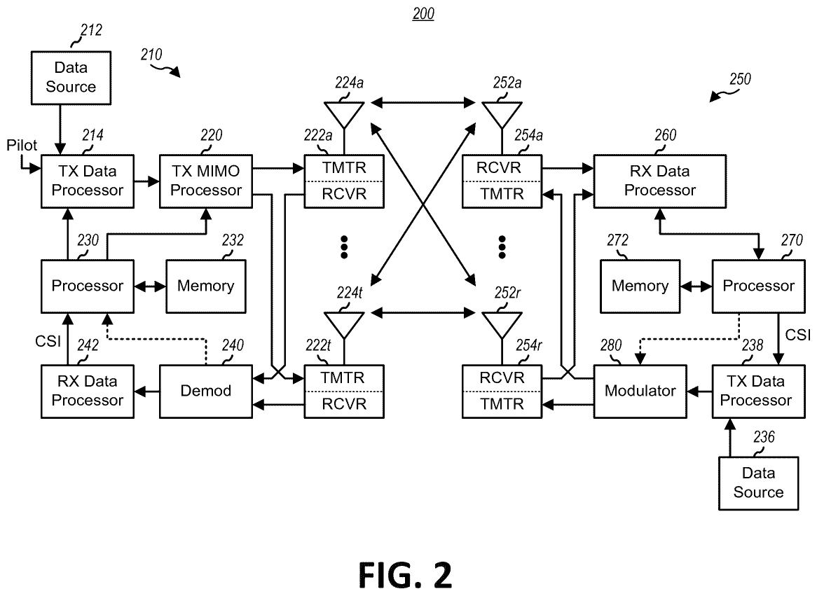

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides NT modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from Nr antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT″ detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

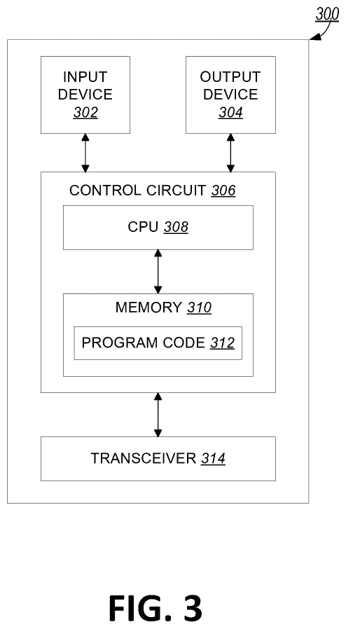

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

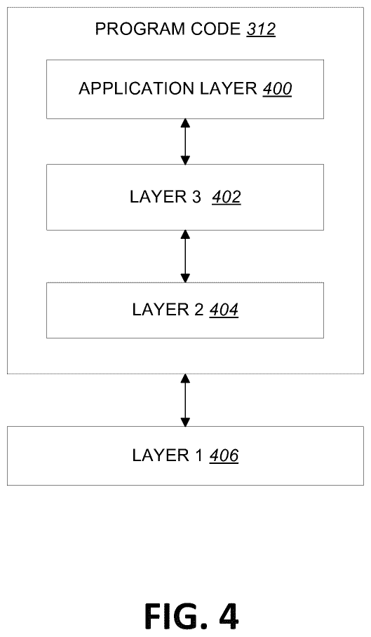

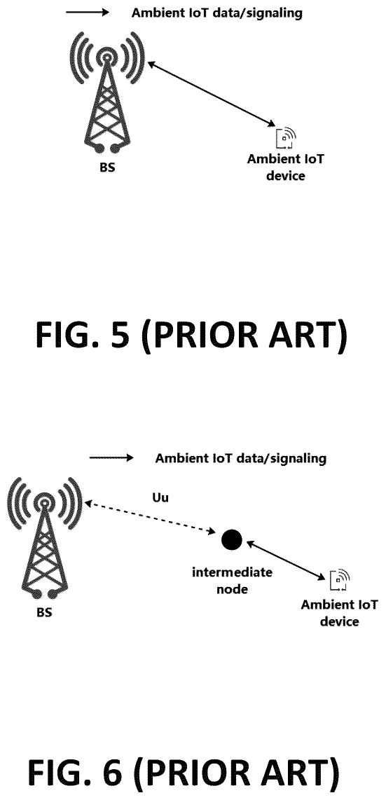

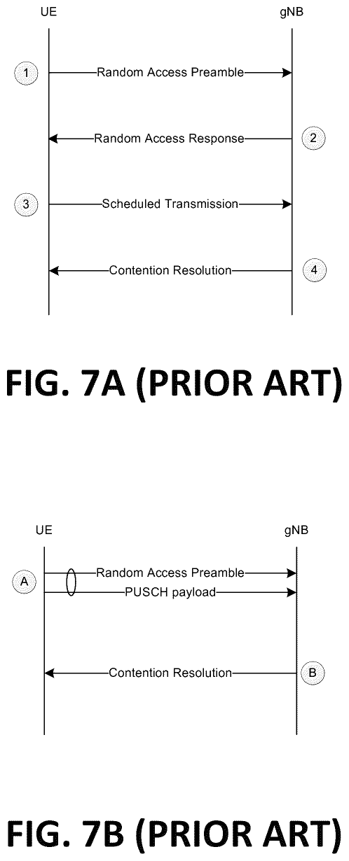

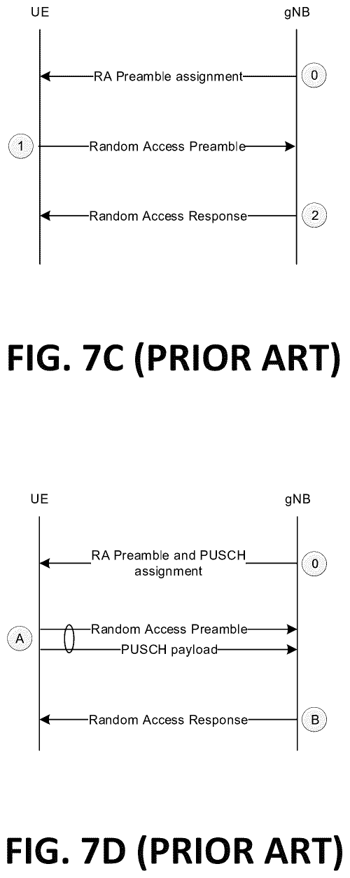

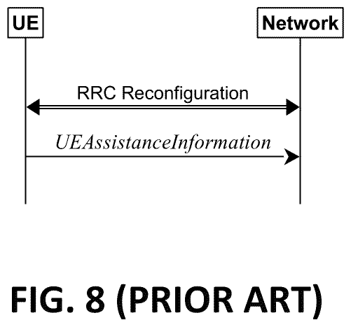

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of Ambient Internet of Things (IoT) has been approved in the RAN plenary #102 meeting. The description is specified in [1] RP-234058, as below:

In 3GPP RAN1 #116 meeting, there are some agreements on ambient Internet of Things (IoT).

For the purpose of the study, RAN1 uses the following terminologies:
Device 1: ˜1μW peak power consumption, has energy storage, initial sampling frequency offset (SFO) up to 10×ppm, neither Downlink (DL) nor Uplink (UL) amplification in the device. The device's UL transmission is backscattered on a carrier wave provided externally.
Device 2a: ≤a few hundred u W peak power consumption, has energy storage, initial Sampling Frequency Offset (SFO) up to 10×ppm, both DL and/or UL amplification in the device. The device's UL transmission is backscattered on a carrier wave provided externally.

Device 2b: <a few hundred μW peak power consumption, has energy storage, initial SFO up to 10× ppm, both DL and/or UL amplification in the device. The device's UL transmission is generated internally by the device.

At least the following bandwidths for Reader to Device (R2D) are defined for the purpose of the study:
Transmission bandwidth, B_{tx,R2D} from a Reader perspective: The frequency resources used for transmitting R2D
Occupied bandwidth, B_{OCC,R2D} from a Reader perspective: The frequency resources used for transmitting R2D, and potential guard band
B_{OCC,R2D}≥B_{tx,R2D}
   FFS (For Further Study): Further constraint(s) e.g., B_{OCC,R2D}=B_{tx,R2D}.
   Possible values of each bandwidth are FFS

From RAN1 perspective, at least when a response is expected from multiple devices that are intended to be identified, an Ambient IoT (A-IoT) contention-based access procedure initiated by the reader is used. At least the following time domain frame structure is studied for A-IoT R2D and A-IoT Device to Reader (D2R) transmission.
For R2D transmission,
   An R2D timing acquisition signal (e.g., R2D preamble) is included at least for timing acquisition and for indicating the start of the R2D transmission in time domain.
For D2R transmission,
   A D2R timing acquisition signal (e.g., D2R preamble) is included at least for timing acquisition and for indicating the start of the D2R transmission in time domain.
FFS other necessary component(s), e.g., midamble, postamble, periodic sync signal, control fields, guard period.

For further discussion, the following terminologies are used for A-IoT for studying processing time aspects:
T_{R2D_min}: Minimum Time between an R2D transmission and the corresponding D2R transmission following it.
T_{D2R_min}: Minimum Time between a D2R transmission and the corresponding R2D transmission following it.
T_{R2D_R2D_min}: Minimum Time between two different consecutive R2D transmissions to the same A-IoT device.
T_{D2R_D2R_min}: Minimum Time between two different consecutive D2R transmissions from the same A-IoT device.
The study should consider at least the following aspects:
   Implementation restrictions for the existing Base Station (BS)/User Equipment (UE).
   [Processing time is common or different for different A-IoT devices].
   [Processing time for different traffic types/command types (e.g., Device-Terminated (DT) or Device-Originated-Device-Terminated Trigger (DO-DTT)) and/or different use cases (e.g., Inventory or Command)].
FFS other timing aspects:
For ambient IoT devices, at least for R2D data transmission, a physical channel (Physical Reader (to Ambient IoT) Device Channel (PRDCH)) is studied,
   System information (if defined) is transmitted on the PRDCH.
   FFS Whether/how control information is transmitted on the PRDCH.
Note: the naming of PRDCH is used for the sake of the study.

For ambient IoT devices, at least for D2R data transmission, a physical channel (Physical (Ambient IoT) Device to Reader Channel (PDRCH)) is studied along with the following:
Response transmitted from device to reader during contention-based access procedure is transmitted on the PDRCH.
   FFS: Details of response.
FFS Whether/how/what D2R control information (if defined) is transmitted on the PDRCH.
Note: the naming of PDRCH is used for the sake of the study.

In recent years, more devices are expected to be interconnected in the wireless communication world for improving productivity efficiency and increasing comforts of life. However, powering all the IoT devices by a battery that needs to be replaced or recharged manually would lead to high maintenance cost, environmental issues, and safety hazards for some use cases, e.g., wireless sensors in electrical power. Further reduction of size, complexity, and power consumption of IoT devices can enable the deployment for various applications (e.g., automated manufacturing, smart home).

On the other hand, barcode and Radio-Frequency Identification (RFID) have limited reading range of a few meters, which usually requires handheld scanning. It would lead to labor intensive and time-consuming operations. Also, the lack of interference management schemes would result in severe interference between RFID readers and capacity problems, especially in cases of dense deployment. It is hard to support a large-scale network with seamless coverage for RFID. In contrast, the study of ambient IoT investigates the feasibility of a new IoT technologies within 3GPP systems.

An ambient IoT device/UE would have ultra-low complexity, very small device size, and a long life cycle. The ambient IoT device/UE would have complexity and power consumption orders of magnitude lower than the existing 3GPP Low Power Wide Area (LPWA) technologies (e.g., Narrowband (NB)-IoT, enhanced Machine Type Communication (eMTC)). The ambient IoT device/UE may not have energy storage or may have energy storage. The energy of an ambient IoT device/UE may be provided through the harvesting of carrier waves, radio waves, light, motion, heat, or any other power source that could be suitable. The energy and/or power source may be provided as one-shot (e.g., unexpected or aperiodically), periodically, or continuously. In one embodiment, the power/energy of the ambient IoT device/UE may be provided from a carrier wave from the network and/or an intermediate node. In Topology 1, the ambient IoT device/UE would directly and bidirectionally communicate with a base station. In Topology 2, the ambient IoT device/UE would communicate bidirectionally with an intermediate node (e.g., a UE or a relay node) between the ambient IoT device/UE and the base station. The UL transmission of the ambient IoT device/UE may be generated internally by the device/UE, or be backscattered on the carrier wave provided externally. More details regarding an ambient IoT (device/UE) could be found in the study item [1] RP-234058, [2] 3GPP TR 38.848 V18.0.0, and agreements from RAN1 #116 meeting.

Since the ambient IoT device/UE would have limited power to perform transmissions and would have limited computation/processing capability, the Network (NW)/reader may not deterministically predict/know information of power status, processing time/delay, and/or data type of an ambient IoT device/UE. It will induce that the NW/reader could be hard/difficult to perform proper scheduling for the ambient IoT device/UE to complete the transmissions.

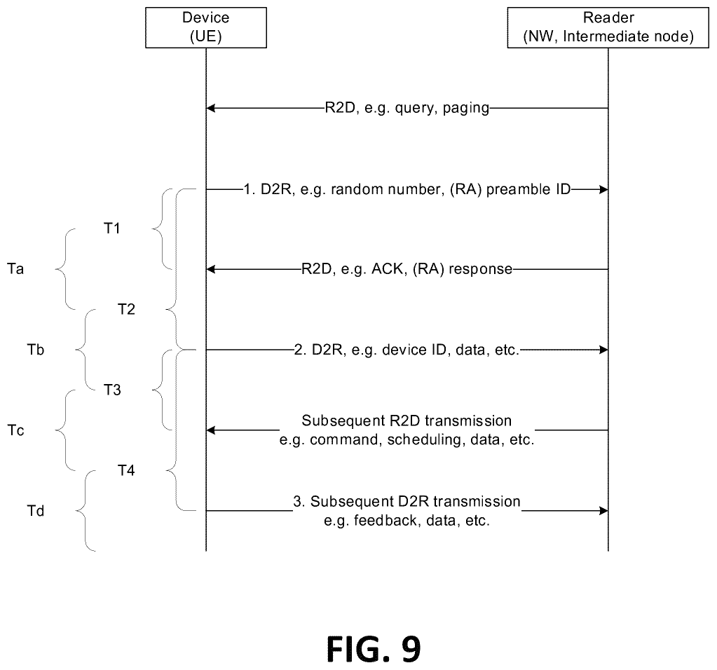

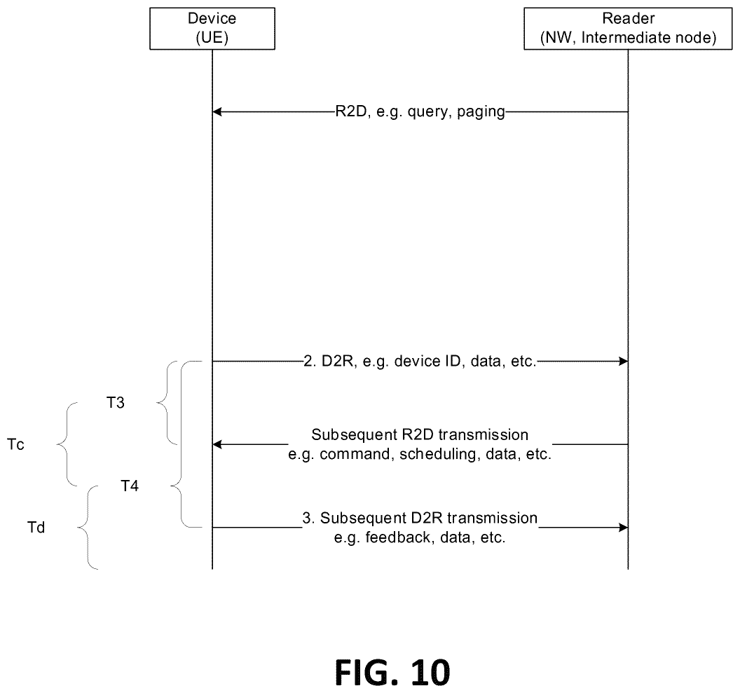

The network would trigger an ambient IoT device to perform a first procedure (e.g., a random access procedure). As shown in FIG. 9 and FIG. 10, in response to receiving a first signaling (e.g., query, paging) from the network, the ambient IoT device would perform one or more D2R transmission(s) and/or R2D reception(s) during the first procedure (e.g., the random access procedure). The ambient IoT device would transmit/perform one or more D2R transmission(s) and/or receive one or more R2D transmission(s) during the first procedure (e.g., the random access procedure). With limited energy capacity, the ambient IoT device may not be always able to perform the transmission(s). The network may not be always in control of real-time energy status of all devices. If (at least) the network schedules the ambient IoT device, which does not have enough energy to perform or complete the first procedure, transmission failure would occur. Such failure not only impacts the network performance but also creates unnecessary collisions, data delay, and resource inefficiencies. For example, the network may schedule extra resources for the failed device(s) to re-access, which could not be used by the device(s) with insufficient remaining energy.

In the following disclosure, the “UE” may be or be replaced by a “device”, an “ambient IoT device” or an “ambient IoT UE”. In the following, the “NW” may be, comprise, or be replaced by a “network node”, a “reader”, an “intermediate node”, or “another UE”. In the following, the “reader” may be or be replaced by a “NW” or a “legacy UE”.

The UE could provide (or transmit) (at least) a first information to the NW/reader, e.g., for providing information of power status, processing time/delay, and/or (available) data (type) of the UE. The UE may perform a D2R transmission carrying (or comprising) the first information. The UE may predict, calculate, derive, and/or determine the first information, e.g., based on its power/energy status and/or processing time/delay. The first information may be a (D2R) control information. The first information may be an assistance information (of ambient IoT). The first information may be, comprise, indicate, and/or be related to (at least) one or more of the following information:

### UE/Device ID

The UE Identification (ID) may be used to identify a UE (e.g., in an area). An identity of the UE and/or a UE ID may be or comprise a random number/value (e.g., RN16), temporary number, preamble number (e.g., Random Access Preamble Identifier (RAPID)), and/or ID, e.g., selected/generated/determined by the UE. An identity of the UE and/or a UE ID may be or comprise a device ID, UE ID, group ID, Contention Resolution Identity and/or Radio Network Temporary identifier (RNTI) of the UE.

The UE ID may be stored by the UE. The UE ID may be a temporary ID. A UE may be assigned a UE ID. The UE may be predefined or (pre-) configured (e.g., by the UE) with the UE ID. The UE may be configured or indicated (e.g., by the NW/reader) with the UE ID. The UE may calculate, select, derive, or determine the UE ID by itself. The UE ID may be ue-Identity.

### UE Group ID

There may be multiple UE groups. A UE may be assigned or associated with a UE group. The UE may be predefined or (pre-) configured (e.g., by the UE) with the UE group. The UE may be configured or indicated (e.g., by the NW/reader) with the UE group. The UE may receive a group ID and/or a value to derive/determine the group ID via query, paging, System Information Block (SIB), and/or PRDCH.

The multiple UEs may be assigned to different UE groups based on the UE types. The UEs with the same UE type may be in a same UE group. The UEs with the same UE type may be in different UE groups. A UE group may comprise UEs with the same or different UE type.

The multiple UEs may be assigned to or associated with different UE groups based on the UE ID. For example, a UE may be assigned to or associated with a UE group, wherein the UE group ID of the UE group may be decided/derived/determined based on at least the UE ID of the UE and a value. Preferably in certain embodiments, the UE group ID of the UE may be decided/derived/determined by the UE ID mod the value. The value may be the number of UE groups. The value may be provided by the NW/reader or be pre-defined or be (pre-) configured. The UE group ID of the UE may be decided by a formula using the UE ID.

The multiple UEs may be assigned to different UE groups based on location. Preferably in certain embodiments, the UEs in a same location and/or same position range may be distributed to a same UE group. A UE may determine/derive its location or range based on a received carrier wave (signal). More specifically, the UE may determine/derive its location or range from a network/reader based on a received power of a carrier wave (signal) transmitted from the network/reader. The UEs in the same location and/or the same range may mean the UEs with the same received power range of the carrier wave (signal). Preferably and/or alternatively in certain embodiments, the UEs in a same location and/or same position range may be distributed to different UE groups. The UEs among the range in which could receive the same power source, carrier wave, and/or NW/reader signal may be (randomly) distributed to different UE groups.

### UE/Device Type

There may be two or more types of UE. The UE types (or device types) may be differentiated by at least power consumption, energy storage, method to perform UL transmission, power level, and/or device size. Preferably in certain embodiments, the method to perform UL transmission may be generated internally by the device/UE or be backscattered on the carrier wave (signal) provided externally. The UE types (or device types) may be or comprise at least device 1, device 2a, and/or device 2b as described in RAN1's agreements. The UE types (or device types) may be or comprise at least device A, device B, and/or device C as considered in [2] TR 38.848 V18.0.0.

For example, a first type UE (e.g., device 1, device A, device B) may have (or be equipped with) battery or energy storage. The first type UE (or device) may not have (or be equipped with) battery or energy storage. The first type UE (or device) may not have (or be equipped with) DL/UL amplification. The first type

UE (or device) may be a passive or semi-passive device. The first type UE (or device) may generate a UL transmission by backscattering. The first type UE (or device) may perform a backscattering transmission. The first type UE (or device) may not be able to generate a UL transmission (internally) by itself. The first type UE (or device) may not have the capability to generate a signal without backscattering.

For example, a second type UE (e.g., device 2a, device 2b, device C) may have (or be equipped with) battery or energy storage. The second type UE (or device) may have (or be equipped with) DL/UL amplification. The second type UE (or device) may be an active device. The second type UE (or device) may generate a UL transmission by backscattering. The second type UE (or device) may perform a backscattering transmission. The second type UE (or device) may be able to generate a UL transmission (internally) by itself. The second type UE (or device) may have capability to generate a signal without backscattering. Energy or power related information

The information may comprise (remaining/available) energy or power, e.g., of energy storage (of the UE). The information may be based on or related to the (remaining/available) energy/power of the UE after a D2R transmission carrying the first information. Alternatively in certain embodiments, the information may be based on or related to the (remaining/available) energy/power of the UE before the D2R transmission carrying the first information. The information may be based on or related to the (remaining/available) energy/power after one or more D2R transmission(s). The information may be represented by power status or power level of the UE.

One or multiple bits may be used to indicate this information. For example, a bit (or the information) set to a first value (e.g., 0) may mean that the (remaining/available) energy/power of the UE is insufficient (for the following D2R transmission(s) and/or R2D reception(s)). The bit (or the information) set to a second value (e.g., 1) may mean that the (remaining/available) energy/power of the UE is sufficient (for the following D2R transmission(s) and/or R2D reception(s)). For example, a bit (or the information) set to a first value may mean that the (remaining/available) energy/power of the UE is in a first power level/status. The bit (or the information) set to a second value may mean that the (remaining/available) energy/power of the UE is in a second power level/status. The first value and second value may indicate an index of a pre-defined power level/status.

Power level

The power level may comprise any one or more of the following embodiments. The UE may utilize same or different power level embodiment(s) for different resources selection step(s), e.g., determination of Bandwidth Part (BWP), determination of (D2R) resources/configuration group, determination of transmission type, determination of (transmission) preamble and/or determination of PDRCH occasion(s). This information may be indicated by (some fields of) a Power Headroom Report (PHR). There may be one or more threshold(s) for power level. The power level may be determined by a threshold(s). The threshold(s) for power level may be configured by the network or be derived by the UE. The threshold(s) for power level may be determined based on the following embodiments and/or a (selected) (D2R) resources/configuration. The threshold(s) for power level may be indicated or configured by the NW/reader. The threshold(s) for power level may be determined by the UE. The threshold(s) for power level may be fixed.

In one embodiment, the power level may be a received power of a signal/channel transmitted from the network. The power level may be a received power of a carrier-wave (signal) transmitted from the network.

In one embodiment, the power level may be a (R2D) pathloss derived/determined based on at least the received power of the signal/channel transmitted from the network. The power level may be a (downlink) pathloss derived/determined based on at least the received power of the carrier-wave (signal) transmitted from the network.

In one embodiment, the power level may be an expected/derived/determined UE transmit power for a backscattering transmission (e.g., a D2R transmission).

In one embodiment, the power level may be an expected/derived/determined UE transmit power for a D2R transmission generated internally by the UE.

In one embodiment, the power level may be a maximum UE transmit power (e.g., for D2R transmission).

In one embodiment, the power level may be the amount of the UE's battery power/stored power/available power. The UE may estimate/determine/derive how much the battery power/stored power/available power is utilizable/available for performing an initial procedure and/or D2R transmission.

In one embodiment, the power level may be a predefine/(pre-) configured/indicated power. The indicated power can be indicated by the network or by the higher layer of the UE. Preferably in certain embodiments, the predefine/(pre-) configured/indicated power can be a guaranteed or required power (amount or capacity) for enabling/activating/starting a (corresponding) initial procedure and/or D2R transmission. Preferably in certain embodiments, the predefine/(pre-) configured/indicated power can be an expected/estimated power consumption (amount) for the completing (corresponding) initial procedure and/or D2R transmission.

In one embodiment, the power level may be a power difference between the (R2D) pathloss and the expected/derived/determined/maximum UE transmit power. The (R2D) pathloss may be derived/determined based on at least received power of the signal/channel, e.g., a carrier wave (signal), from the network. The expected/derived/determined UE transmit power may be for a backscattering transmission or for a (D2R) transmission generated internally by the UE.

In one embodiment, the power level may be a power difference between the battery power/stored power/available power and the expected/derived/determined/maximum UE transmit power. The expected/derived/determined UE transmit power may be for a backscattering transmission or for D2R transmission generated internally by the UE. The UE may estimate/determine/derive how much the battery power/stored power/available power is utilizable for performing a (corresponding) initial procedure and/or D2R transmission.

In one embodiment, the power level may be a power difference between a predefine/(pre-) configured/indicated power and the expected/derived/determined/maximum UE transmit power. The indicated power can be indicated by the network or by the higher layer of the UE. Preferably in certain embodiments, the predefine/(pre-) configured/indicated power can be a guaranteed or required power (amount or capacity) for enabling/activating/starting a (corresponding) initial procedure and/or D2R transmission. Preferably in certain embodiments, the predefine/(pre-) configured/indicated power can be an expected/estimated power consumption (amount) for completing a (corresponding) initial procedure and/or

D2R transmission. The expected/derived/determined UE transmit power may be for a backscattering transmission or for D2R transmission generated internally by the UE.

Data type (or transmission type)

The data type (or transmission type) may indicate the type of the (D2R) transmission (or data). The data type (or transmission type) may indicate traffic information (e.g., TrafficInfo in [5] TS 38.331 V18.0.0), use case, traffic scenario, service type, Quality of Service (QOS), (logical) channel (group), and/or topology. The data type (or transmission type) may be (or include): 2-step, 4-step, initial, subsequent, data, signaling, Device-Originated (DO), DO-Device-Terminated Triggered (DO-DTT), Device-Terminated (DT), one-shot, data burst, periodic, aperiodic, delay tolerant, and/or emergency.

(D2R) data size

The (D2R) data size may be calculated/derived/determined by the UE. The (D2R) data size may be corresponding to the (D2R) data type. The (D2R) data size may be a (potential/pending) Transport Block Size (TBS) of a (D2R) transmission and/or a PDRCH transmission. The (D2R) data size may be a (potential/pending) TBS of the transmission(s) in a first procedure. The (D2R) data size may be a TBS of ambient IoT information (or data). The (D2R) data size may be a minimum size that the UE can use to perform a (data) transmission. The (D2R) data size may be a preferred value that the UE can use to perform a (data) transmission. The (D2R) data size may be a pending, available, or remaining data size before the UE goes to sleep and/or aborts a first procedure.

Information related to (data) traffic

The information may be (or include, or indicate) at least one or more of the following: a traffic pattern, (expected) time information related to data (or packet) arrival, how long until the (next) data is expected to arrive, latency requirement of the data (or packet), priority of the data (or packet), importance of the data (or packet), the expected time of the (next) data arrival, (expected) data inter-arrival time, a period of data arrival. Information related to processing time/delay

The information may be (or include, or indicate) at least one or more of the following: (required, expected, minimum) time information related to processing/computation/measurement, how long the current/pending data is expected/capable to transmit/report, how long until the (next) data is expected to transmit, the (required/expected) time of (next) data transmission, a (required/expected) period of data processing, a (required/expected) period of data transmission, an indication or flag for (in-) processing (delay), an indication or flag for indicating a “ready to transmission/report” or a “not yet ready to transmission/report”, an indication or flag for indicating a transmission/report delay or not.

Information related to UE wake up (or active)

The information may be (or include, or indicate) at least one or more of the following: (expected or preferred) wake up time of the UE, time information related to UE wake up, information related to UE active time (e.g., estimated (minimum or maximum) remaining time to be active), information related to UE inactive time (e.g., estimated (minimum or maximum) remaining time to go to sleep), the time that the UE will wake up (or expect to wake up), how long until the next time the UE will wake up or go to sleep. The UE waking up or active may represent that the UE monitors an R2D signaling and/or PRDCH. The UE going to sleep or inactive may represent that the UE does not monitor an R2D signaling and/or PRDCH.

One or multiple bits may be used to indicate this information. For example, a bit (or the information) set to a first value (e.g., 0, 1) may mean that the UE would go to sleep, e.g., after transmitting the transmission carrying the first information.

### (Required) Repetition Number

The information may be related to a (required) repetition number (used) for a D2R transmission and/or a PDRCH transmission. The repetition may comprise an initial transmission and (following) retransmissions. The repetition may be or comprised by a bundled transmission.

### Number of the Transmission

The transmission number may be how many additional (Transmission Time Interval (TTI)/occasion or size for) D2R transmissions could be performed (e.g., based on the remaining/available energy/power). The additional D2R transmissions may be the D2R transmissions other than or after the D2R transmission carrying the first information.

The transmission number may be how many additional (TTI/occasion or size for) R2D receptions/monitorings could be performed (e.g., based on the remaining/available energy/power). The additional R2D receptions/monitorings may be the R2D receptions other than or after a first signaling (as described below).

The transmission number may be how many additional pairs of D2R transmissions and R2D receptions/monitorings could be performed (e.g., based on the remaining/available energy/power). The additional pairs of transmissions/receptions may be the transmissions other than or after the D2R transmission carrying the first information and the first signaling (as described below).

The transmission number may be a number of slots/TTIs/occasions, number of bits or bytes, amount of data, number of (complete) transmissions/receptions, number of PDRCH transmissions, and/or number of PRDCH receptions/monitoring. The transmission number may or may not include repetition(s).

The size may be in a unit of bit or byte. The size may be in a unit of Transport Block (TB) or TTI.

### Position or Location Information

The information may be (or include, or indicate) a coordinate of the UE. The information may be (or include, or indicate) an area where the UE is located. The information may be (or include, or indicate) an area ID. The area may be (or include) a cell, a tracking area, or a range of area scope.

### Time Information for Next/Corresponding R2D Reception

The time information may be, comprise, be replaced by, be referred to, be represented by, and/or be indicated by a time duration, a timer (value), and/or an indication (e.g., of duration level). The time information may be a (minimum) (required) time of energy or power accumulation for the next/corresponding R2D reception or monitoring of the R2D transmission (e.g., after the D2R transmission carrying the first information). In other words, the UE may not perform (the next) R2D reception or monitor (the next) R2D transmission before the end of the time indicated by this information. The time information may be T1 and/or T3 in FIG. 9 (as described below). The time information may be T3 in FIG. 10 (as described below).

The time indicated by this information may be started (in a first TTI/occasion) after the end of a D2R transmission carrying this information.

The first information (e.g., time information) may be provided if the (required) time is larger than the required (minimum) processing time. The first information (e.g., time information) may not be provided if the (required) time is not larger than the required (minimum) processing time. The first information (e.g., time information) may not be provided if the (required) time is smaller than or equal to the required (minimum) processing time.

The first information (e.g., the time information for next/corresponding R2D reception) may be provided if the time information for the next/corresponding R2D reception is larger than a (pre-) configured/specified minimum processing time. The first information (e.g., the time information for next/corresponding R2D reception) may not be provided if the time information for the next/corresponding R2D reception is not larger than (i.e., smaller than or equals to) the (pre-) configured/specified minimum processing time. The (pre-) configured/specified minimum processing time may be/mean a minimum Time between a D2R transmission and the corresponding R2D transmission following it, e.g., noted as TD2R_min.

The time duration may be represented by a number of TTIs/occasions.

### Time Information for Next D2R Transmission

The time information may be, comprise, be replaced by, be referred to, be represented by, and/or be indicated by a time duration, a timer (value), and/or an indication (e.g., of duration level). The time information may be a (minimum) (required) time of energy or power accumulation for the next D2R transmission (e.g., after the D2R transmission carrying the first information). In other words, the UE may not (expect to) perform (the next) D2R transmission before the end of the time indicated by this information. The time information may be T2 and/or T4 in FIG. 9 (as described below). The time information may be T4 in FIG. 10 (as described below).

The time indicated by this information may be started (in a first TTI/occasion) after the end of a D2R transmission carrying this information.

The first information (e.g., time information) may be provided if the (required) time is larger than the required (minimum) processing time. The first information (e.g., time information) may not be provided if the (required) time is not larger than the required (minimum) processing time. The first information (e.g., time information) may not be provided if the (required) time is smaller than or equal to the required (minimum) processing time.

The first information (e.g., the time information for next D2R transmission) may be provided if the time information for the next D2R transmission is larger than a (pre-) configured/specified minimum processing time. The first information (e.g., the time information for next D2R transmission) may not be provided if the time information for the next D2R transmission is not larger than (i.e., smaller than or equals to) the (pre-) configured/specified minimum processing time. The (pre-) configured/specified minimum processing time may be/mean a Minimum Time between two different consecutive D2R transmissions from the same UE, e.g., noted as TD2R_D2R_min.

The time duration may be represented by a number of TTIs/occasions.

Time Information for Suggested (or Preferred) R2D Reception and/or Suggested D2R Transmission

The time information may be, comprise, be replaced by, be referred to, be represented by, and/or be indicated by a time duration, a timer (value), and/or an indication (e.g., of duration level).

The time information may indicate a suggested (or expected/preferred) time (duration) or expiry/expiration time for reception/monitoring of Acknowledge (ACK), NW/reader response, response to D2R transmission, and/or the next or subsequent R2D reception. The time information may indicate a suggested (or expected/preferred) time (duration) or expiry time for scheduling for the next or subsequent D2R transmission (e.g., third transmission in FIG. 9 or FIG. 10). The scheduling for a subsequent D2R transmission may be provided in an R2D transmission (e.g., ACK or subsequent R2D transmission in FIG. 9 or subsequent R2D transmission in FIG. 10). Before the start of the time, the UE may not (expect to) receive or monitor ACK, NW/reader response, response to D2R transmission, the next or subsequent R2D reception, and/or scheduling for the next or subsequent D2R transmission. After the end of the time or after the expiry time, the UE may not (expect to) receive or monitor ACK, NW/reader response, response to D2R transmission, the next or subsequent R2D reception, and/or scheduling for the next or subsequent D2R transmission. The time information may be Ta and/or Te in FIG. 9 (as described below). The time information may be Tc in FIG. 10 (as described below).

The time information may indicate a suggested (or expected/preferred) time (duration) or expiry time for the next or subsequent D2R transmission (e.g., second transmission and/or third transmission in FIG. 9 or third transmission in FIG. 10). Before the start of the time, the UE may not (expect to) perform the next or subsequent D2R transmission. After the end of the time or after the expiry time, the UE may not (expect to) perform the next or subsequent D2R transmission. The time information may be Tb and/or Td in FIG. 9 (as described below). The time information may be Td in FIG. 9 (as described below).

The time information may indicate a starting point (e.g., TTI) of the time. The time information may indicate a length (e.g., TTI) of the time. The time information may indicate an ending point (e.g., TTI) of the time.

### Cause

The cause may indicate at least one or more of the following: a DO-DTT (device originated-device terminated triggered) (transmission), a DT (device terminated) (transmission), a DO (device originated) transmission, an ambient IoT (transmission), a non-ambient IoT (transmission), a reason for aborting a first procedure, a status of a first information, a fulfillment of a condition, whether a first signaling is needed.

Note that any of the above and herein methods, alternatives, concepts, examples, and embodiments may be combined, in whole or in part, or applied simultaneously or separately.

The UE could receive a first signaling (e.g., paging) to trigger a first procedure (e.g., a random access procedure). During the first procedure (e.g., the random access procedure), the UE could provide an energy information in a first transmission, indicating whether the remaining energy of the UE is sufficient or not for (at least) one or more (following) transmission(s) or reception(s) after the first transmission. The energy information may indicate at least one of: whether the remaining energy of the UE is sufficient (or not) for the one or more (following) transmission(s) or reception(s) after the first transmission, the remaining energy of the UE is insufficient for the one or more (following) transmission(s) or reception(s) after the first transmission, or (whether) the remaining energy of the UE is insufficient to complete the random access procedure.

The first transmission may be a D2R transmission during the first procedure (e.g., the random access procedure). The one or more (following) transmission(s) or reception(s) may be or comprise one or more D2R transmission(s) and R2D reception(s) during the first procedure (e.g., the random access procedure). The energy information may indicate a first value if, when, in response to, and/or based on the remaining energy of the UE is sufficient. The energy information may indicate a second value if, when, in response to, and/or based on the remaining energy of the UE is insufficient. The UE may not provide the energy information if, when, in response to, and/or based on the remaining energy of the UE is sufficient. The UE may provide the energy information if, when, in response to, and/or based on the remaining energy of the UE is insufficient. The UE may stop the first procedure (e.g., the random access procedure) after, if, when, in response, to and/or based on providing the energy information indicating the remaining energy of the UE being insufficient.

As shown in FIG. 9 and FIG. 10, the UE may perform a first procedure, e.g., for ambient IoT. The first procedure may be contention-based or contention-free. The first procedure may comprise both contention-based and contention-free transmissions. The first procedure may be an (ambient IoT) data transmitting procedure, (ambient IoT) response procedure, or (ambient IoT) reporting procedure. The first procedure may be a procedure of Random Access (RA), (initial) access, (ambient IoT) response/report, and/or (R2D/D2R) transmission. The first procedure may be and/or comprise a transmission(s). The UE may access the NW/reader, receive signaling/message/configuration, and/or transmit (D2R) data via the procedure.

The UE may receive a first signaling from the NW/reader. The UE may perform (or initiate) the first procedure in response to (or based on) the first signaling.

The first signaling may be a query, a paging, a System Information Block (SIB), a Radio Resource Control (RRC) message (e.g., RRC setup request), a Medium Access Control (MAC) signaling (e.g., MAC Control Element (CE)) and/or a Physical (PHY) signaling (e.g., PRDCH, Physical Downlink Control Channel (PDCCH), Downlink Control Information (DCI)). The first signaling may be (or include) a carrier wave (signal), R2D signal/channel, and/or interrogation signal. The first signaling may be (or include) a common signaling. The first signaling may be (or include) a cell-specific signaling. The first signaling may be (or include) a broadcast signaling. The first signaling may be received by multiple UEs (or a group of UEs), e.g., in a UE group. The first signaling may be (or include) a dedicated signaling. The first signaling may be (or include) a UE-specific signaling.

The first signaling may be used to trigger (or indicate) an (random) access procedure, transmission(s), and/or reception(s) of the UE. The transmission from the UE may be (or include) a backscattering transmission (or reception) or may be generated internally by the UE. The first signaling may indicate which/what (kind of) UE(s) should respond to the first signaling. The first signaling may indicate which/what (kind of) UE(s) is allowed to perform (or initiate) the access procedure, transmission(s), and/or reception(s). The first signaling may indicate configuration(s) to be used for a (subsequent) (data) transmission or reception (or procedure).

As shown in FIG. 9, in response to receiving the first signaling, the UE may transmit a first transmission to the NW/reader, e.g., based on a first condition. The NW/reader may transmit an ACK to the UE in response to reception/detection/decoding of the first transmission. In response to or after transmitting the first transmission, the UE may receive the ACK from the NW/reader. In response to receiving, recognizing, and/or decoding the ACK, the UE may transmit a second transmission to the NW/reader. The NW/reader may transmit a subsequent R2D transmission to the UE in response to reception/detection/decoding of the second transmission, e.g., if there would be subsequent R2D and/or D2R transmission(s). In response to or after transmitting the second transmission, the UE may or may not receive the subsequent R2D transmission from the NW/reader. In response to receiving the subsequent R2D transmission, the UE may transmit a third transmission to the NW/reader.

As shown in FIG. 10, in response to receiving the first signaling, the UE may transmit the second transmission to the NW/reader, e.g., based on a second condition. The NW/reader may transmit a subsequent R2D transmission to the UE in response to reception/detection/decoding of the second transmission, e.g., if there would be a subsequent R2D and/or D2R transmission(s). In response to or after transmitting the second transmission, the UE may or may not receive the subsequent R2D transmission from the NW/reader. In response to receiving the subsequent R2D transmission, the UE may transmit a third transmission to the NW/reader.

The first condition may be (partially or fully) different from the second condition.

In response to receiving the first signaling, the UE may determine to perform the first transmission based on at least whether the first condition is fulfilled or not. In response to receiving the first signaling, the UE may determine to perform the second transmission based on at least whether the second condition is fulfilled or not.

Alternatively in certain embodiments, the second condition may be the same as the first condition.

In response to receiving the first signaling, the UE may determine to perform the first transmission based on at least the first condition is fulfilled, and the UE may determine to perform the second transmission based on at least the first condition is not fulfilled.

The first condition may be one or more of the following:
The first signaling includes an indication (e.g., (complete) UE ID);
A first procedure is performed at the first time for the UE (e.g., after the UE powers on or becomes active);
The UE has not performed a first procedure (e.g., after the UE powers on or becomes active);
A first signaling is received at the first time (e.g., after the UE powers on or becomes active);
UE powers on or becomes active, e.g., in response to the first signaling;
A first transmission has not been transmitted to the NW (e.g., after the UE powers on or becomes active);
UE ID has not been transmitted to the NW/reader (e.g., after the UE powers on or becomes active);
An ACK (to a first transmission) has not been received and/or decoded by the UE (e.g., after UE powers on or becomes active);
The last first procedure, last first transmission, or last reception of ACK (to first transmission) has been outdated;
The time duration between the current time and the time of performing the last first procedure, last first transmission, last reception of ACK (to first transmission) is above a threshold;
A timer is not running or has been expired; and/or
A (last) first procedure or (last) first transmission is invalid (or is not valid).

The second condition may be one or more of the following:
The first signaling includes an indication (e.g., (complete) UE ID);
A first procedure is not performed at the first time for the UE (e.g., after the UE powers on or becomes active);
The UE has performed a first procedure (e.g., after the UE powers on or becomes active);
A first signaling is not received at the first time (e.g., after the UE powers on or becomes active);
A first transmission has been transmitted to the NW/reader (e.g., after the UE powers on or becomes active);
UE ID has been transmitted to the NW/reader (e.g., after the UE powers on or becomes active);
An ACK (to a first transmission) has been received and/or decoded by the UE (e.g., in a performed/previous first procedure and/or after the UE powers on or becomes active);
The last first procedure, last first transmission, or last reception of ACK (to first transmission) has been kept and/or is not outdated;
The time duration between the current time and the time of performing the last first procedure, last first transmission, last reception of ACK (to first transmission) is not above a threshold;
A timer is running or not expired; and/or
A (last) first procedure or (last) first transmission is valid.

The threshold may be configured/indicated by the NW/reader or be derived/determined by the UE.

The threshold may be fixed or pre-defined. The threshold may be a time offset or time duration.

The timer may be related to the first procedure. The timer may be a validity timer. The timer may be a prohibit timer. The timer may be started in response to performing the first transmission. The timer may be started in response to receiving the ACK to the first transmission. The timer may be started in response to triggering the first procedure.

Preferably in certain embodiments, the D2R transmission carrying the first information may be any of the first transmission, the second transmission, the third transmission, and/or the subsequent D2R transmission(s).

In one or more examples, the UE/device may receive a first signaling (e.g., a paging) from the NW/reader. The first signaling may indicate the UE/device to trigger a first procedure (e.g., a random access procedure). In response to receiving the first signaling, the UE may trigger the first procedure. In response to receiving the first signaling, the UE may transmit a first transmission to the NW/reader, e.g., during the first procedure. The UE may provide a first information (e.g., an energy information) in the first transmission. The first information may indicate a first value if (at least) the remaining energy of the UE is sufficient, e.g., for receiving a response for the first transmission and/or transmitting a second transmission. The first information may indicate a second value if (at least) the remaining energy of the UE is insufficient, e.g., for receiving a response for the first transmission and/or transmitting a second transmission. The UE may not provide the first information if (at least) the remaining energy of the UE is sufficient, e.g., for receiving a response for the first transmission and/or transmitting a second transmission. The UE may provide the first information if (at least) the remaining energy of the UE is insufficient, e.g., for receiving a response for the first transmission and/or transmitting a second transmission. The UE may stop or suspend the first procedure in response to providing the first information. The UE may not stop or suspend the first procedure in response to providing the first information. The UE may stop the first procedure in response to the first information indicating the second value.

In one or more examples, the UE/device may receive a first signaling (e.g., a paging) from the NW/reader. The first signaling may indicate the UE/device to trigger a first procedure (e.g., a random access procedure). In response to receiving the first signaling, the UE may trigger the first procedure. In response to receiving the first signaling, the UE may transmit a first transmission to the NW/reader, e.g., during the first procedure. The NW/reader may transmit a response to the UE in response to reception/detection/decoding of the first transmission. In response to or after transmitting the first transmission, the UE may receive the response for the first transmission from the NW/reader. In response to receiving, recognizing, and/or decoding the response for the first transmission, the UE may transmit a second transmission to the NW/reader. The UE may provide a first information (e.g., an energy information) in the second transmission. The first information may indicate a first value if (at least) the remaining energy of the UE is sufficient, e.g., for receiving a response for the second transmission and/or transmitting a third transmission. The first information may indicate a second value if (at least) the remaining energy of the UE is insufficient, e.g., for receiving a response for the second transmission and/or transmitting a third transmission. The UE may not provide the first information if (at least) the remaining energy of the UE is sufficient, e.g., for receiving a response for the second transmission and/or transmitting a third transmission. The UE may provide the first information if (at least) the remaining energy of the UE is insufficient, e.g., for receiving a response for the second transmission and/or transmitting a third transmission. The UE may stop or suspend the first procedure in response to providing the first information. The UE may not stop or suspend the first procedure in response to providing the first information. The UE may stop the first procedure in response to the first information indicating the second value.

In one or more examples, the UE/device may receive a first signaling (e.g., a paging) from the NW/reader. The first signaling may indicate the UE/device to trigger a first procedure (e.g., a random access procedure). In response to receiving the first signaling, the UE may trigger the first procedure. In response to receiving the first signaling, the UE may transmit a first transmission to the NW/reader, e.g., during the first procedure. The NW/reader may transmit a response to the UE in response to reception/detection/decoding of the first transmission. In response to or after transmitting the first transmission, the UE may receive the response for the first transmission from the NW/reader. In response to receiving, recognizing, and/or decoding the response for the first transmission, the UE may transmit a second transmission to the NW/reader. The NW/reader may transmit a subsequent R2D transmission (e.g., a response for the second transmission) to the UE in response to reception/detection/decoding of the second transmission, e.g., if there is an (available) subsequent R2D and/or D2R transmission(s). In response to or after transmitting the second transmission, the UE may or may not receive the subsequent R2D transmission from the NW/reader. In response to receiving the subsequent R2D transmission, the UE may transmit a third transmission to the NW/reader. The UE may provide a first information (e.g., an energy information) in the third transmission. The first information may indicate a first value if (at least) the remaining energy of the UE is sufficient, e.g., for receiving a response for the third transmission and/or transmitting a fourth transmission. The first information may indicate a second value if (at least) the remaining energy of the UE is insufficient, e.g., for receiving a response for the third transmission and/or transmitting a fourth transmission. The UE may not provide the first information if (at least) the remaining energy of the UE is sufficient, e.g., for receiving a response for the third transmission and/or transmitting a fourth transmission. The UE may provide the first information if (at least) the remaining energy of the UE is insufficient, e.g., for receiving a response for the third transmission and/or transmitting a fourth transmission. The UE may stop or suspend the first procedure in response to providing the first information. The UE may not stop or suspend the first procedure in response to providing the first information. The UE may stop the first procedure in response to the first information indicating the second value.

Throughout the present disclosure, a following (D2R/R2D) transmission may be and/or comprise at least a subsequent (D2R/R2D) transmission, e.g., after a first transmission. The first transmission may be a D2R transmission during a first procedure.

There may be one or more following (D2R/R2D) transmission(s) based on an indication/information in a first signaling. There may be one or more following (D2R/R2D) transmission(s) based on data arrival at the device/reader.

The first transmission may be/comprise information of a random number, information of a preamble number, and/or information of a (access) ID selected/generated/determined by the UE.

The ACK may be an (initial) response to the first transmission. The ACK may indicate, identify, and/or correspond to the first transmission. The ACK may provide and/or indicate resource(s) for the following D2R transmissions, e.g., the second transmission and/or the third transmission.

The second transmission may be/comprise information of a device/UE ID, report, assistance information, D2R data, and/or information from the UE.

The subsequent R2D transmission be a response to the second transmission, a (R2D) command, R2D data and/or a scheduling. The subsequent R2D transmission may indicate, identify, and/or correspond to the second transmission. The subsequent R2D transmission may provide resource(s) for the following D2R transmissions, e.g., the third transmission. The subsequent R2D transmission may indicate, notify, and/or allow the third transmission.

The third transmission may be/comprise a feedback (of the subsequent R2D transmission), report, assistance information, D2R data, and/or information from the UE.

The first transmission, second transmission, and third transmission may be D2R transmissions and/or PDRCH transmissions. The third transmission may be a subsequent D2R transmission. The first signaling, ACK, and subsequent R2D transmission may be R2D transmissions and/or PRDCH transmissions. The first signaling and ACK may be broadcast, provided, and/or transmitted to one or multiple UEs. The ACK and subsequent R2D transmission may be provided and/or transmitted to a dedicated UE. There may be one or more subsequent R2D transmission(s) and/or subsequent D2R transmission(s) during and/or after a first procedure.

The UE may transmit the first information via the first transmission, second transmission, and/or third transmission. The first information may be carried by the first transmission, second transmission, and/or third transmission. The UE may not transmit the first information via the first transmission. The first information may not be carried by the first transmission. The UE may monitor PDRCH based on the first information. The NW may schedule and/or perform the ACK, second transmission, subsequent R2D transmission, and/or third transmission based on the first information. The NW may transmit an R2D transmission and/or scheduling to the UE based on the first information.

The UE may determine to transmit a first information (e.g., in a first procedure) based on (at least) a second condition is fulfilled. The second condition may be one or more of the following:
Status of the first information (e.g., a specific status/type/value of the first information) is derived by the UE and/or indicated by the NW (e.g., via a first signaling);
If the first information is available;
If the remaining energy/power is insufficient to complete the procedure (e.g., the first procedure), receive the R2D transmission/response, and/or transmit the remaining/available data;
If the (expected) power level is or would be below a threshold for the power level;
If the available (remaining) data size is larger than a threshold of TBS (as described below);
If the (required) processing time is or would be above a threshold of time (as described below);
If the UE is expected to go to sleep, e.g., before completing the remaining transmission and/or the first procedure;
If the UE does not receive an R2D transmission at or before the timing of T1, T3, Ta, and/or Tc; and/or
If the (required) time of energy/power accumulation for the next reception, transmission, or monitoring is larger than the (required) processing time or the threshold of time.

The T1 and T3 (e.g., in FIG. 9 or FIG. 10) may be an (expected or prohibited or delayed) time interval between a D2R transmission and a (corresponding) R2D transmission. The T2 and T4 (e.g., in FIG. 9 or FIG. 10) may be an (expected or prohibit or delay) time interval between two (consecutive) D2R transmissions. The Ta and Tc (e.g., in FIG. 9 or FIG. 10) may be an (expected/required/minimum) time interval to receive a (corresponding) R2D transmission (e.g., after performing a D2R transmission). The Tb and Td (e.g., in FIG. 9 or FIG. 10) may be an (expected/required/minimum) time interval to transmit a (corresponding) D2R transmission (e.g., after receiving an R2D transmission).

The T1 may be the time duration between the first transmission and the (expected or prohibited or delayed arrival time of) the ACK. The T1 may indicate the expected or prohibited or delayed arrival time of the ACK to the first transmission. The UE may start or expect to receive the ACK after/at (the end of) the first transmission plus T1. The UE may (start to) monitor PRDCH after/at (the end of) the first transmission plus T1.

The T2 may be the time duration between the first transmission and the (expected or prohibited or delayed transmission time of) second transmission. The T2 may indicate the expected or prohibited or delayed transmission time of the second transmission. The UE may start or expect to transmit the second transmission after/at (the end of) the first transmission plus T2. The UE may receive a scheduling for the second transmission, wherein the scheduling indicates PDRCH resource(s) after/at (the end of) the first transmission plus T2.

The T3 may be the time duration between the second transmission and the (expected or prohibited or delayed arrival time of) subsequent R2D transmission. The T3 may indicate the expected or prohibited or delayed arrival time of the subsequent R2D transmission. The UE may start or expect to receive the subsequent R2D transmission after/at (the end of) the second transmission plus T3. The UE may (start to) monitor PRDCH after/at (the end of) the first transmission plus T3.

The T4 may be the time duration between the second transmission and the (expected or prohibited or delayed transmission time of) third transmission. The T4 may indicate the expected or prohibited or delayed transmission time of the third transmission. The UE may start or expect to transmit the third transmission after/at (the end of) the second transmission plus T4. The UE may receive a scheduling for the third transmission, wherein the scheduling indicates PDRCH resource(s) after/at (the end of) the second transmission plus T4.

The Ta may be the time duration when the UE expects to receive the ACK. The Ta may indicate the expected arrival time of the ACK to the first transmission. The UE may monitor PRDCH during the time duration of Ta.

The Tb may be the time duration when the UE expects to transmit the second transmission. The Tb may indicate the expected transmission time of the second transmission. The UE may receive a scheduling for the second transmission, wherein the scheduling indicates PDRCH resource(s) during the time duration of Tb.

The Tc may be the time duration when the UE expects to receive the subsequent R2D transmission. The Tc may indicate the expected arrival time of the subsequent R2D transmission. The UE may monitor PRDCH during the time duration of Tc.

The Td may be the time duration when the UE expects to transmit the third transmission. The Td may indicate the expected transmission time of the third transmission. The UE may receive a scheduling for the third transmission, wherein the scheduling indicates PDRCH resource(s) during the time duration of Td.

The UE may determine to abort, delay, stop, terminate, or suspend a first procedure, e.g., based on a third condition, if at least a third condition is fulfilled. The UE may transmit a request (e.g., to the NW, to the reader) to abort, stop, terminate, or suspend a first procedure, e.g., based on a third condition, if at least a third condition is fulfilled. The third condition may be (or comprise, or be related to) that if the remaining/available energy/power is insufficient to complete the procedure, receive the R2D transmission/response and/or transmit the remaining/pending/available data. The third condition may be (or comprise, or be related to) the first information and/or processing time. The UE may determine to resume the first procedure, e.g., based on a third condition, if at least a third condition is not fulfilled. The UE may transmit a request (e.g., to the NW, to the reader) to resume the first procedure, e.g., based on a third condition, if at least a third condition is fulfilled.

In one example, the UE may stop, terminate, or suspend a first procedure if the (expected) remaining/available energy/power is or would be not enough to performing the remaining transmission(s) (e.g., second transmission, third transmission, subsequent R2D/D2R transmission). The UE may resume the first procedure if the (expected) remaining/available energy/power is or would be enough to perform the remaining transmission (e.g., second transmission, third transmission, subsequent R2D/D2R transmission).

In one example, the UE may stop, terminate, or suspend a first procedure if the (expected/available) power level is or would be below a threshold for power level (as described above). The UE may resume the first procedure if the (expected/available) power level is or would be above (or equal to) the threshold for power level (as described above).

In one example, the UE may stop, terminate, or suspend a first procedure if the available/pending (remaining) data size is larger than the threshold of TBS. The threshold may be determined or associated with power level. The threshold may be configured/indicated by the network or be derived/determined by the UE. The threshold may be fixed or pre-defined.

In one example, the UE may stop, terminate, or suspend a first procedure if the (expected/required) processing time is or would be above a threshold of time. The threshold may be determined or associated with power level. The threshold may be configured/indicated by the network or be derived/determined by the UE. The threshold may be fixed or pre-defined.

In one example, the UE may stop, terminate, or suspend a first procedure if the UE is expected to go to sleep, e.g., before completing the remaining transmission(s) (e.g., second transmission, third transmission, subsequent R2D/D2R transmission) and/or the first procedure. The UE may resume the first procedure if the UE is expected to wake up.

In one example, the UE may stop, terminate, or suspend a first procedure if the UE does not receive an R2D transmission at or before the timing indicating by T1, T3, Ta and/or Tc.

In one example, the UE may stop, terminate, or suspend a first procedure if a specific status/type/value of a first information is indicated by the NW, e.g., via query, paging, and/or PRDCH.

When or in response to stopping, terminating, or suspending a first procedure, the UE may transmit a first information and/or a second information to the NW/reader. The UE may transmit a first information and/or a second information before stopping, terminating, or suspending the first procedure. For example, the UE may determine to stop, terminate, or suspend the first procedure. In response to the determination, the UE may transmit a first information and/or a second information, e.g., via a D2R transmission in the first procedure. In response to the transmission of the first information and/or the second information, the UE may stop, terminate, or suspend the first procedure. The UE may transmit a first information and/or a second information to the NW in the request to stop, terminate, or suspend a first procedure.

The second information may include at least one of the following:
Pending data is available (or not);
Reason/cause to stop or abort the first procedure;
Reason/cause to delay or suspend the first procedure;
Need to be queried/paged again (later) (or not);
Need to perform the first procedure again (later) (or not);
Suggested/preferred/expected/required wait time before performing the first procedure again; and/or
Suggested/preferred/expected/required wait time before being queried/paged again.

Any of the above and herein methods, alternatives, concepts, examples, and embodiments may be combined, in whole or in part, or applied simultaneously or separately.

Throughout the present disclosure, the following may be interchangeable: DL and/or R2D. An R2D transmission may be a transmission from a reader to a device. An R2D data may be (available) data on a reader side and/or data to be transmitted from a reader to a device. An R2D transmission and/or R2D data may comprise an indication, configuration, signaling, and/or message from a reader. An R2D reception may be a reception of an R2D transmission.

Throughout the present disclosure, the following may be interchangeable: UL and/or D2R. A D2R transmission may be a transmission from a device to a reader. A D2R data may be (available) data on a device side and/or data to be transmitted from a device to a reader. A D2R transmission and/or D2R data may comprise an indication, signaling, and/or message from a device. A D2R resource and/or PDRCH resource may be or comprise a UL grant and/or resource provided from the reader/NW/intermediate node, used by the device/UE, and/or used to transmit/perform D2R transmission.

Throughout the present disclosure, the reader may be and/or be replaced by NW, UE, and/or intermediate node. Throughout the present disclosure, the device may be and/or be replaced by UE and/or intermediate node. The device may be referred to as an ambient IoT device. The “UE” may comprise a reader and/or device. The “NW” may comprise a reader. The UE/device may receive carrier wave(s) from a reader. The UE/device may receive carrier wave(s) from a node other than the reader.

Throughout the present disclosure, the following may be interchangeable: RA, access, initial access, and/or (ambient IoT) transmission. The resource(s) and/or configuration(s) for the access procedure may comprise PDRCH resource(s), PDRCH occasion(s), frequency and/or band, e.g., for D2R transmission. The resource(s) and/or configuration(s) for the access procedure may comprise a parameter, random number, group number, and/or assistance information, e.g., for D2R transmission.

Throughout the present disclosure, the following may be interchangeable: Physical Random Access Channel (PRACH), Random Access Channel (RACH), Physical Uplink Shared Channel (PUSCH), Physical Uplink Control Channel (PUCCH), and/or PDRCH. The PDRCH may be or be referred to as a channel for transmission from device to reader. The PDRCH may be or be referred to as a (physical) channel for ambient IoT. The PDRCH may be or be referred to as a (physical) channel for D2R (data/control) transmission. The PDRCH may comprise PRACH, RACH, PUSCH, and/or PUCCH. An R2D transmission may be transmit via a PRDCH. The (data and/or signaling) transmission from reader to device/UE may be via PRDCH.

Throughout the present disclosure, the following may be interchangeable: Physical Downlink Shared Channel (PDSCH), Physical Downlink Control Channel (PDCCH), and/or PRDCH. The PRDCH may be or be referred to as a channel for transmission from reader to device. The PRDCH may be or be referred to as a (physical) channel for ambient IoT. The PRDCH may be or be referred to as a (physical) channel for R2D (data/control) transmission. The PRDCH may comprise PDSCH and/or PDCCH. A D2R transmission may be transmitted via a PDRCH. The (data and/or signaling) transmission from device/UE to reader may be via PDRCH.

The UE may receive configurations related to ambient IoT. The UE may receive configurations and/or resources for performing the first procedure. The resource(s) and/or configuration(s) may comprise PDRCH (transmission) resource(s), occasion(s), channel resource(s), frequency resources, and/or (sub-) band(s), e.g., for D2R transmission. The resource(s) and/or configuration(s) may comprise a parameter, random number, group number, and/or assistance information, e.g., for D2R transmission. The UE may monitor/receive the PRDCH in the first procedure.

Throughout the present disclosure, a time information may be a value of time duration, a value/indication of (starting) timing (e.g., Universal Time Coordinated (UTC) time, a TTI), a time offset (e.g., to a transmission), and/or an indication/index of time/duration level/status. The time information may be related to the first information, processing delay/time, energy/power accumulation, data type/size, wake up time, go to sleep time, PRDCH monitoring, R2D reception, D2R transmission, and/or a configuration/indication provided by the NW. The time information may be an expected, preferred, required, or suggested time calculated by the UE based on power/energy and/or processing time.

Throughout the present disclosure, a scheduling may be one or more PDRCH resource(s) for D2R transmission(s) and/or one or more PRDCH resource(s) for R2D reception(s). The scheduling may be (an indication of) a timing and/or frequency.

Throughout the present disclosure, the following may be interchangeable: suggested, preferred, expected, required, and/or estimated.

Throughout the present disclosure, the following may be interchangeable: “initiate a procedure”, “perform a procedure”, “trigger a procedure”, and/or “execute a procedure.”

Throughout the present disclosure, the “BWP” may be replaced by “system bandwidth”, “channel bandwidth”, “transmission bandwidth”, “occupation bandwidth”, “sub-band of/in a cell”, “frequency (resource(s))”, “band”, and/or “subset of the total cell bandwidth of a cell”.

Throughout the present disclosure, the “reader” may be/mean or replaced by “network node” or “intermediate node”. The intermediate node may be a legacy UE.

Throughout the present disclosure, the “cell” may be replaced by “intermediate node”.

Throughout the present disclosure, the network (node) may be changed/represented/replaced as intermediate node.

Throughout the present disclosure, the “downlink control information” may be replaced by R2D control information.

Throughout the present disclosure, the “uplink control information” may be replaced by D2R control information.

Throughout the present disclosure, the downlink control information may be transmitted via a PRDCH or R2D command.

Throughout the present disclosure, the TTI/occasion may be a (time) occasion, a symbol, a set of symbols, a slot, a set of slots, and/or a subframe.

Throughout the present disclosure, the “transmission” may be replaced by “message”.

The UE may be referred to as the UE, an RRC layer of the UE, a MAC entity of the UE, or a physical layer of the UE.

Throughout the present disclosure, the UE may be a device used for ambient IoT. The UE may be a device capable of ambient IoT. The UE may be an NR device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: (ambient IoT) UE, (ambient IoT) device. Throughout the present disclosure, the following may be interchangeable: normal UE, legacy UE.

The UE may not be a legacy UE. The legacy UE may be a non-ambient IoT device. The legacy UE may perform different procedures from the ambient IoT UE. The UE may be a legacy UE with capability to perform an ambient IoT procedure. The legacy UE may be an NR UE.

The network may be a network node. The network (node) may be a base station. The network (node) may be an access point. The network (node) may be an Evolved Node B (eNB). The network (node) may be a Next Generation Node B (gNB). The network (node) may be a gateway.

Various examples and embodiments of the present invention are described below. For the methods, alternatives, concepts, examples, and embodiments detailed above and herein, the following aspects and embodiments are possible.

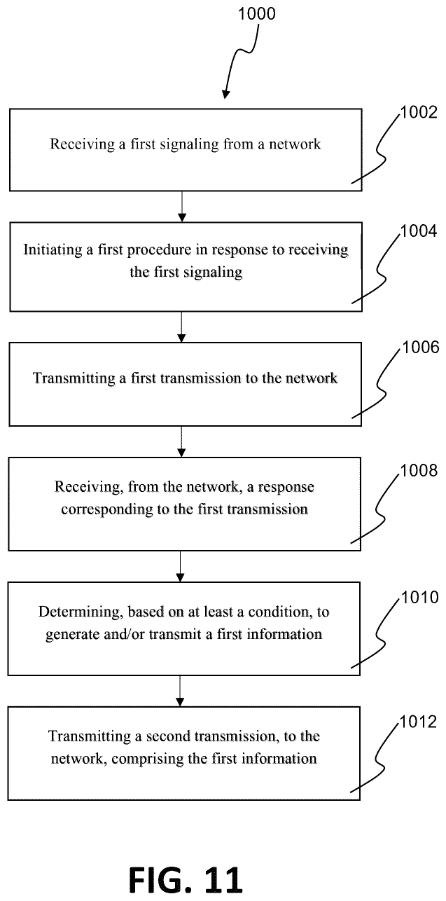

Referring to FIG. 11, with this and other concepts, systems, and methods of the present invention, a method 1000 for a UE in a wireless communication system comprises receiving a first signaling from a network (step 1002), initiating a first procedure in response to receiving the first signaling (step 1004), transmitting a first transmission to the network (step 1006), receiving, from the network, a response corresponding to the first transmission (step 1008), determining, based on at least a condition, to generate and/or transmit a first information (step 1010), and transmitting a second transmission, to the network, comprising the first information (step 1012).

In various embodiments, the first signaling is a broadcast message, a query, and/or a paging for ambient IoT.

In various embodiments, the first signaling indicates the UE to perform the first procedure.

In various embodiments, the first procedure is an (random) access procedure (for ambient IoT), a transmission procedure (for ambient IoT), an information exchange procedure (for ambient IoT), a report procedure (for ambient IoT), and/or a response procedure (for ambient IoT).

In various embodiments, the first transmission comprises an identification of the UE.

In various embodiments, the identification of the UE is a random number generated by the UE. In various embodiments, the response indicates the identification of the UE.

In various embodiments, the response is an acknowledgement dedicated to the UE.

In various embodiments, the condition is that the remaining energy/power of the UE is insufficient to complete the first procedure.

In various embodiments, the condition is that the remaining energy/power of the UE is insufficient to perform transmission(s) and/or reception(s) after the second transmission.

In various embodiments, the first information comprises device identification, power information, energy status, time information, and/or data type.

In various embodiments, the UE is an ambient IoT device.

In various embodiments, the network is an ambient IoT reader, an intermediate node, a gNB, and/or another UE.

In various embodiments, the another UE is a legacy UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling from a network; (ii) initiate a first procedure in response to receiving the first signaling; (iii) transmit a first transmission to the network; (iv) receive, from the network, a response corresponding to the first transmission; (v) determine, based on at least a condition, to generate and/or transmit a first information; and (vi) transmit a second transmission, to the network, comprising the first information. Moreover, the CPU 308 can execute the program code 312 to perform all of the described actions, steps, and methods described above, below, or otherwise herein.

Referring back to FIGS. 3 and 4, in one or more embodiments from the perspective of a network in a wireless communication system, the device 300 includes a program code 312 stored in memory 310 of the transmitter. The CPU 308 could execute program code 312 to: (i) transmit a first signaling to a UE; (ii) receive a first transmission from the UE; (iii) transmit, to the UE, a response corresponding to the first transmission; and (iv) receive a second transmission, from the UE, comprising a first information. Moreover, the CPU 308 can execute the program code 312 to perform all of the described actions, steps, and methods described above, below, or otherwise herein.

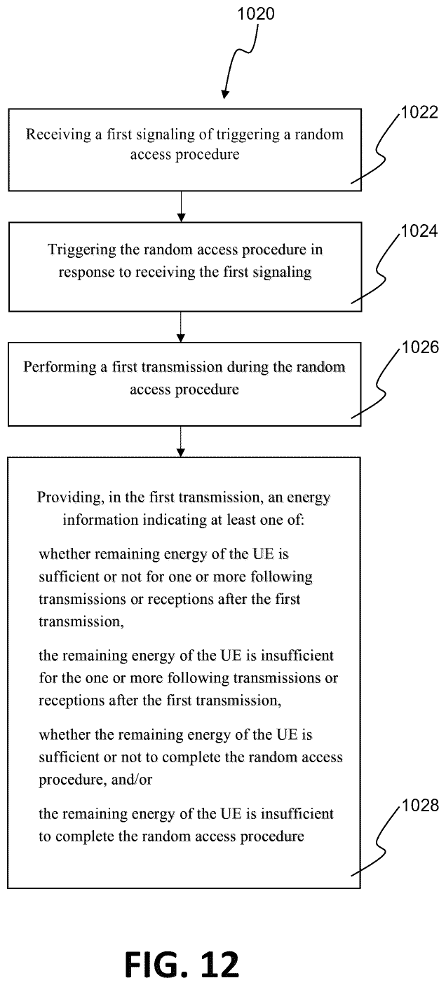

Referring to FIG. 12, with this and other concepts, systems, and methods of the present invention, a method 1020 for a UE in a wireless communication system comprises receiving a first signaling of triggering a random access procedure (step 1022), triggering the random access procedure in response to receiving the first signaling (step 1024), performing a first transmission during the random access procedure (step 1026), and providing, in the first transmission, an energy information indicating at least one of: whether remaining energy of the UE is sufficient or not for one or more following transmissions or receptions after the first transmission, the remaining energy of the UE is insufficient for the one or more following transmissions or receptions after the first transmission, whether the remaining energy of the UE is sufficient or not to complete the random access procedure, and/or the remaining energy of the UE is insufficient to complete the random access procedure (step 1028).

In various embodiments, the energy information indicates a first value when the remaining energy of the UE is sufficient, and the energy information indicates a second value when the remaining energy of the UE is insufficient.

In various embodiments, the energy information is not provided in the first transmission (or the first transmission does not provide/include the energy information) when the remaining energy of the UE is sufficient, and the energy information is provided in the first transmission (or the first transmission provides/includes the energy information) when the remaining energy of the UE is insufficient.

In various embodiments, the energy information is one bit.

In various embodiments, the energy information means power information.

In various embodiments, the energy information is a power status of the UE or an energy status of the UE.

In various embodiments, the method further comprises stopping or suspending the random access procedure in response to providing the energy information indicating the remaining energy of the UE being insufficient.

In various embodiments, the first transmission is a D2R transmission during the random access procedure.

In various embodiments, the one or more following transmissions or receptions comprise performing (at least) a D2R transmission and/or receiving (at least) an R2D transmission during the random access procedure.

In various embodiments, the UE performs the first transmission in response to receiving the first signaling.

In various embodiments, the first signaling is a paging for ambient IoT.

In various embodiments, the first signaling is for more than one UE including the UE, and/or the first signaling indicates at least the more than one UE.

In various embodiments, the first signaling is received from a reader and/or the first transmission is transmitted to the reader, and wherein the reader is a network or another UE.

In various embodiments, the UE is an ambient IoT device.

In various embodiments, the another UE is a legacy UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling of triggering a random access procedure; (ii) trigger the random access procedure in response to receiving the first signaling; (iii) perform a first transmission during the random access procedure; and (iv) provide, in the first transmission, an energy information indicating at least one of: whether remaining energy of the UE is sufficient or not for one or more following transmissions or receptions after the first transmission, the remaining energy of the UE is insufficient for the one or more following transmissions or receptions after the first transmission, whether the remaining energy of the UE is sufficient or not to complete the random access procedure, and/or the remaining energy of the UE is insufficient to complete the random access procedure. Moreover, the CPU 308 can execute the program code 312 to perform all of the described actions, steps, and methods described above, below, or otherwise herein.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit, to a UE, a first signaling of triggering a random access procedure; (ii) receive, from the UE, a first transmission during the random access procedure; and (iii) acquire, in the first transmission, an energy information indicating at least one of: whether remaining energy of the UE is sufficient or not for one or more following transmissions or receptions after the first transmission, the remaining energy of the UE is insufficient for the one or more following transmissions or receptions after the first transmission, whether the remaining energy of the UE is sufficient or not to complete the random access procedure, and/or the remaining energy of the UE is insufficient to complete the random access procedure. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first signaling of triggering a random access procedure;
triggering the random access procedure in response to receiving the first signaling;
performing a first transmission during the random access procedure; and
providing, in the first transmission, an energy information indicating at least one of:
whether remaining energy of the UE is sufficient or not for one or more following transmissions or receptions after the first transmission;
the remaining energy of the UE is insufficient for the one or more following transmissions or receptions after the first transmission;
whether the remaining energy of the UE is sufficient or not to complete the random access procedure; and/or
the remaining energy of the UE is insufficient to complete the random access procedure.

2. The method of claim 1, wherein the energy information indicates a first value when the remaining energy of the UE is sufficient, and the energy information indicates a second value when the remaining energy of the UE is insufficient.

3. The method of claim 1, wherein the energy information is not provided in the first transmission when the remaining energy of the UE is sufficient, and the energy information is provided in the first transmission when the remaining energy of the UE is insufficient.

4. The method of claim 1, wherein:
the energy information is one bit, and/or
the energy information means power information, and/or
the energy information is a power status of the UE or an energy status of the UE.

5. The method of claim 1, further comprising stopping or suspending the random access procedure in response to providing the energy information indicating the remaining energy of the UE being insufficient.

6. The method of claim 1, wherein the first transmission is a Device-to-Reader (D2R) transmission during the random access procedure.

7. The method of claim 1, wherein the one or more following transmissions or receptions comprise performing at least a D2R transmission and/or receiving at least a Reader-to-Device (R2D) transmission during the random access procedure.

8. The method of claim 1, wherein the UE performs the first transmission in response to receiving the first signaling.

9. The method of claim 1, wherein the first signaling is a paging for ambient Internet of Things (IoT), the first signaling is for more than one UE including the UE, and/or the first signaling indicates at least the more than one UE, and/or wherein the UE is an ambient IoT device.

10. The method of claim 1, wherein the first signaling is received from a reader and/or the first transmission is transmitted to the reader, and wherein the reader is a network or another UE.

11. A User Equipment (UE), comprising:
a memory; and
a processor operatively coupled with the memory, wherein the processor is configured to execute a program code to:
receive a first signaling of triggering a random access procedure;
trigger the random access procedure in response to receiving the first signaling;
perform a first transmission during the random access procedure; and
provide, in the first transmission, an energy information indicating at least one of:
whether remaining energy of the UE is sufficient or not for one or more following transmissions or receptions after the first transmission;
the remaining energy of the UE is insufficient for the one or more following transmissions or receptions after the first transmission;
whether the remaining energy of the UE is sufficient or not to complete the random access procedure; and/or
the remaining energy of the UE is insufficient to complete the random access procedure.

12. The UE of claim 11, wherein the energy information indicates a first value when the remaining energy of the UE is sufficient, and the energy information indicates a second value when the remaining energy of the UE is insufficient.

13. The UE of claim 11, wherein the energy information is not provided in the first transmission when the remaining energy of the UE is sufficient, and the energy information is provided in the first transmission when the remaining energy of the UE is insufficient.

14. The UE of claim 11, wherein:
the energy information is one bit, and/or
the energy information means power information, and/or
the energy information is a power status of the UE or an energy status of the UE.

15. The UE of claim 11, wherein the processor is further configured to execute the program code to: stop or suspend the random access procedure in response to providing the energy information indicating the remaining energy of the UE being insufficient.

16. The UE of claim 11, wherein the first transmission is a Device-to-Reader (D2R) transmission during the random access procedure.

17. The UE of claim 11, wherein the one or more following transmissions or receptions comprise performing at least a D2R transmission and/or receiving at least a Reader-to-Device (R2D) transmission during the random access procedure.

18. The UE of claim 11, wherein the UE performs the first transmission in response to receiving the first signaling.

19. The UE of claim 11, wherein the first signaling is a paging for ambient Internet of Things (IoT), the first signaling is for more than one UE including the UE, and/or the first signaling indicates at least the more than one UE, and/or wherein the UE is an ambient IoT device.

20. The UE of claim 11, wherein the first signaling is received from a reader and/or the first transmission is transmitted to the reader, and wherein the reader is a network or another UE.
